(19) United States
(12) Patent Application Publication
(10) Pub. No.: US 2026/0312308 A1
(43) Pub. Date: Oct. 8, 2026

(54) DEVICE FOR PROTECTING AGAINST PARTIAL DISCHARGES

(71) Applicant: SOURIAU, VERSAILLES CEDEX (FR)

(72) Inventors: Edgar LEBRUN, LE MANS (FR); Franck AITA, ELANCOURT (FR)

(21) Appl. No.: 19/482,768

(22) PCT Filed: May 14, 2024
(86) PCT No.: PCT/EP2024/063150

§ 371 Date: Nov. 9, 2025

(30) Foreign Application Priority Data
May 15, 2023 (FR) 2304820

(51) Int. Cl. H01R 4/70; H01R 4/18; H01R 4/34; H01R 13/52; H01R 13/53

(52) U.S. Cl. CPC H01R 4/70; H01R 4/18; H01R 4/34; H01R 13/521; H01R 13/53

(57) ABSTRACT

A device to protect against partial discharges. The device includes a connector having a housing, an insulator and an electrical conductor. The insulator is positioned inside the housing and includes a through-hole. The electrical conductor is positioned inside the through-hole of the insulator. The insulator includes a conductive layer on part of the outer surface of the insulator. The conductive layer is positioned between the housing and the insulator.

### TECHNICAL FIELD OF THE INVENTION

The present invention relates to a device for protecting against partial discharges. It applies in particular to the field of electrical insulation and connectivity.

### PRIOR ART

Assembling a connector component with insulation requires functional clearances between the parts. This results in air layers between the parts. From an electric field value in the air zone, partial discharges appear in these air layers and these discharges lead to a degradation of the insulation and then a premature breakdown thereof.

At altitude, the pressure is reduced, which facilitates the appearance of partial discharges. The voltage resistance of the insulation is therefore reduced at altitude.

Some prior-art documents also propose devices protecting as partial discharges. For example, publication document EP4092689 is known, which describes an electrical cable limiting partial discharges.

However, this invention may have drawbacks and is not transposable to connectors.

Document US2017294770 and document 2010115769 also exist, but do not satisfy the needs mentioned below.

### DISCLOSURE OF THE INVENTION

The present invention aims to overcome these drawbacks with a totally innovative approach.

More specifically, the invention aims to provide a device for eliminating partial discharges in air zones.

In particular, an objective of the invention is to provide such a technique making it possible to dispense with any other complex adjustment system.

An objective of the invention is to provide such a device, which can be easily adapted to existing systems.

These objectives, as well as others that will appear later, are achieved, according to a first aspect, using a partial-discharge protection device, said device comprises a connector comprising:
a housing;
an insulator positioned inside the housing and comprising a through hole;
an electrical conductor positioned inside the through hole of the insulator;
remarkable in that the insulator includes a first conductive layer on a part of the outer surface of the insulator, said conductive layer being positioned between the housing and the insulator; the insulator includes a second conductive layer on a part of its inner surface, the end of the first conductive layer or of the second conductive layer extends beyond the housing and on either side of the housing.

Thanks to these arrangements, the second conductive layer makes it possible to minimize partial discharges between the insulator and the electrical conductor. In one embodiment, the conductive layer is obtained by surface preparation by abrasion, application of resist, chemical metallization layer then electrodeposition.

Thanks to these provisions, this protective device by metallization of the insulators makes it possible to limit the occurrence of partial discharges by very strongly reducing the electrical field in the air layer located between the outer face of the insulator and the housing.

According to one variant, the housing is of circular cylindrical shape. According to another variant, the housing has a circular cylindrical shape with a flat.

According to one variant, the housing is rectangular in shape.

The invention is advantageously implemented according to the embodiments and variants set forth below, which are to be considered individually or according to any technically feasible combination.

In one embodiment, the electrical conductor includes a surface for contact with the insulator.

In one embodiment, the insulator extends between two ends, each end including an end insulator and/or an elastomer part.

Thanks to these arrangements, the end insulator and/or the elastomer part make it possible to eliminate triple points. A triple point (air-insulator-conductor interface) being a concentration point of the electric field that facilitates the appearance of partial discharges.

Thanks to these arrangements, this extension of the insulator makes it possible to move the triple point away from the device.

In one embodiment, the ends of the first conductive layer or of the second conductive layer are covered by a flexible seal.

Thanks to these arrangements, the seals make it possible to have a seal and cut the leakage lines between the electrical conductor and the unit.

In one embodiment, the connector includes seals positioned between the insulator and the housing or between the insulator and the electrical conductor and covering the end of the conductive layers.

For example, O-rings maintain a high pressure between the housing and the insulator, which reduces the occurrence of partial discharges.

### BRIEF DESCRIPTION OF THE FIGURES

Other advantages, aims and features of the present invention will emerge from the following description made, for an explanatory and non-limiting purpose, with reference to the appended drawings, wherein:

FIG. 1 shows an application of a partial-discharge protection device;

FIG. 2 shows another partial-discharge protection device;

FIG. 3 shows the association of the two previous partial-discharge protection devices;

FIG. 4 shows a partial-discharge protection device with the use of a coating;

FIG. 5 shows a partial-discharge protection device with an extension of the insulator;

FIG. 6 shows a partial-discharge protection device with a clip;

FIG. 7 shows an isometric view of the partial-discharge protection device;

FIG. 8 shows an exploded view of the assembly of the protective device with the connector;

FIG. 9 shows a sectional view of the assembly of the protective device with the connector; and

FIG. 10 shows a detail view of the previous figure.

### DESCRIPTION OF THE EMBODIMENTS

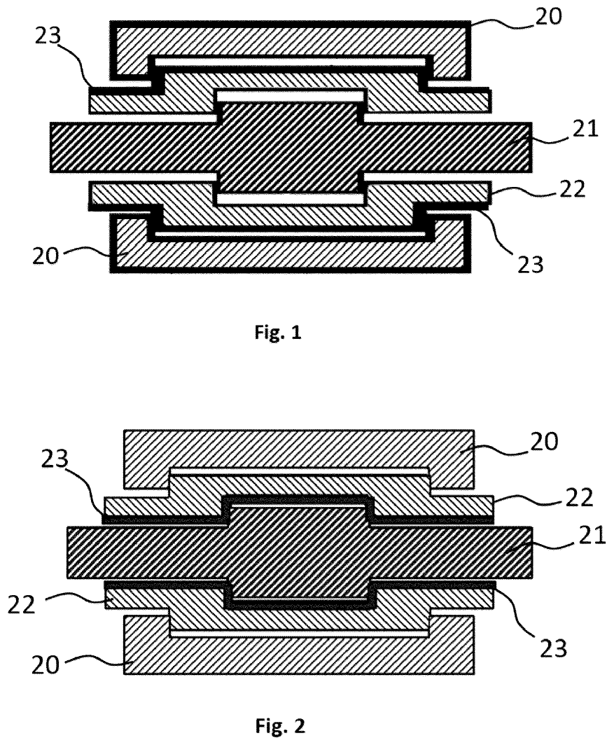

FIG. 1 shows an application of a partial-discharge protection device.

The application example shows components.

The components are a housing 20, an electrical conductor 21, and an insulator 22.

According to one variant, the housing 20 is of circular cylindrical shape, and it is assembled with an electrical conductor 21.

According to another variant, the housing 20 is of circular cylindrical shape with a flat.

A flat is a flat or crushed surface of a generally cylindrical or bar-shaped object, which is used to provide a specific contact area or bearing surface in a given application.

The housing 20 ensures the protection of the electrical conductor 21 and of the insulator 22 and holds the insulator 22.

According to one variant, the housing 20 is metallic or made of metallized plastic, and connected to the electrical ground.

The insulator 22 includes a conductive layer 23, and a through hole, and is positioned inside the housing 20.

The conductive layer 23 is positioned on the outer surface of the insulator 22.

The conductive layer 23 is represented as a black line in the figure.

According to one variant, the conductive layer 23 is conductive or semiconductor. This makes it possible to obtain a zero electrical field between the insulator 22 and the housing 20, and therefore to avoid partial discharges in the air layer between the two parts.

The term partial discharge represents an electrical breakdown in an air layer. The air layer in question relates to functional clearances between the housing 20 and the insulator 22. The voltage at which partial discharges occur can be calculated with Paschen's law.

Paschen's law is an empirical law that makes it possible to determine the voltage of the appearance of an electric arc in a gas.

An empirical law is a functional relationship based on observation and experience, rather than on logical deduction or mathematical demonstration.

According to one variant, the conductive layer 23 includes a surface of contact with the housing 20.

Depending on the connector environment, the clearances are filled with air or another gas.

The device shows clearances between the insulator 22 and the electrical conductor 21.

The electrical conductor 21 is positioned inside the hole passing through the insulator 22.

The use of an electrical conductor 21 allows the transport of the electrical power.

The electrical conductor 21 has a surface of contact with the insulator 22.

According to one variant, the electrical conductor 21 is composed of male and female electrical contacts connected to a cable or a busbar.

Naturally, the invention is described in the foregoing by way of example. It is understood that a person skilled in the art is able to implement various variant embodiments of the invention without however departing from the scope of the invention.

FIG. 2 shows another partial-discharge protection device.

This example includes the same characteristics as that of the previous figure but with a major difference.

According to one variant, the insulator 22 includes a conductive layer 23 on its inner surface.

This conductive layer 23 makes it possible to reduce the risk of partial discharges occurring between the electrical conductor 21 and the insulator 22.

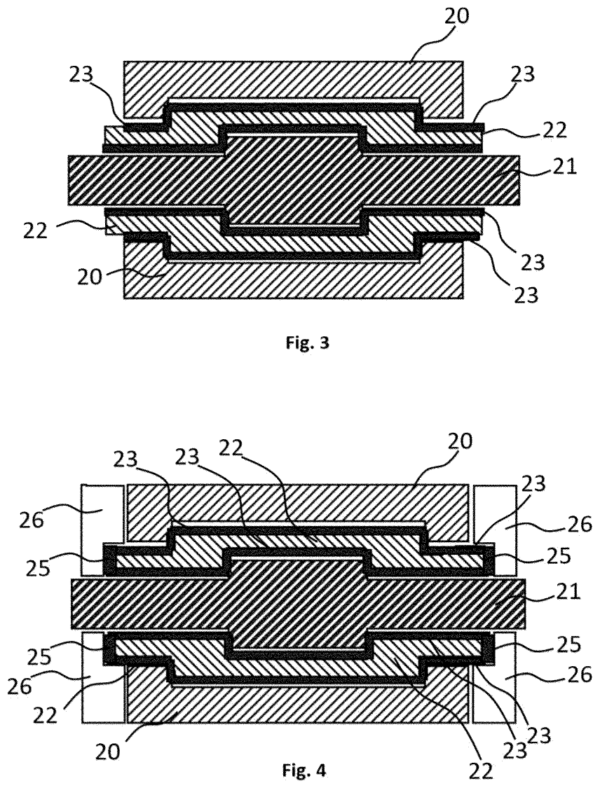

FIG. 3 shows the association of the two previous partial-discharge protection devices.

The insulator 22 includes a conductive layer 23 on its inner and outer surface.

This association makes it possible to minimize the occurrence of partial discharge over the entire invention.

FIG. 4 shows a partial-discharge protection device with the use of a coating.

This figure shows the same features as the previous figures but with the addition of a coating.

A flexible seal is positioned at the ends of the insulator 22.

According to one example, the flexible seal comprises elastomeric parts, or a complementary end insulator 26.

The use of a flexible seal makes it possible to have a seal and to ensure the functioning of protection at various pressures to which the connector 21 is subjected.

An elastomeric part is a part made from an elastomer material, which is a type of polymer material having elastic properties. Elastomers are characterized by their ability to deform under the effect of a stress or force, and to return to their original shape and size when the stress is released.

The use of several elastomeric parts or of a complementary end insulator 26 makes it possible to eliminate triple points.

Triple points represent the junction between the air, the insulator 22, and the electrical conductor 21 or the conductive layer 23. The position of the triple points results in partial discharges, hence the use of a coating.

According to one variant, the complementary end insulator 26 is an insulating coating such as paint, or varnish.

According to one variant, the triple dots are eliminated by compressing elastomeric parts, which eliminates the presence of air in this area.

According to one variant, the elastomeric parts are O-ring seals.

O-ring seals are ring-shaped, circular sealing parts made of elastomer materials.

According to one variant, the elastomeric parts are compressed by end insulating parts 26.

The use of end insulating parts 26 further makes it possible to lengthen the pathway distances and the distances in air to increase the breakdown voltage.

The end insulating parts 26 are positioned outside the housing 20.

FIG. 5 shows a partial-discharge protection device with an extension of the insulator 22.

This figure has the same features as that of the previous figures.

The extension of the insulator 22 extends vertically, and passes round the housing 20.

The conductive layer 23 located on the outer surface of the insulator 22 is extended between the housing 20 and the extension of the insulator 22.

The extension of the insulator 22 makes it possible to move the triple points away from the connector 21.

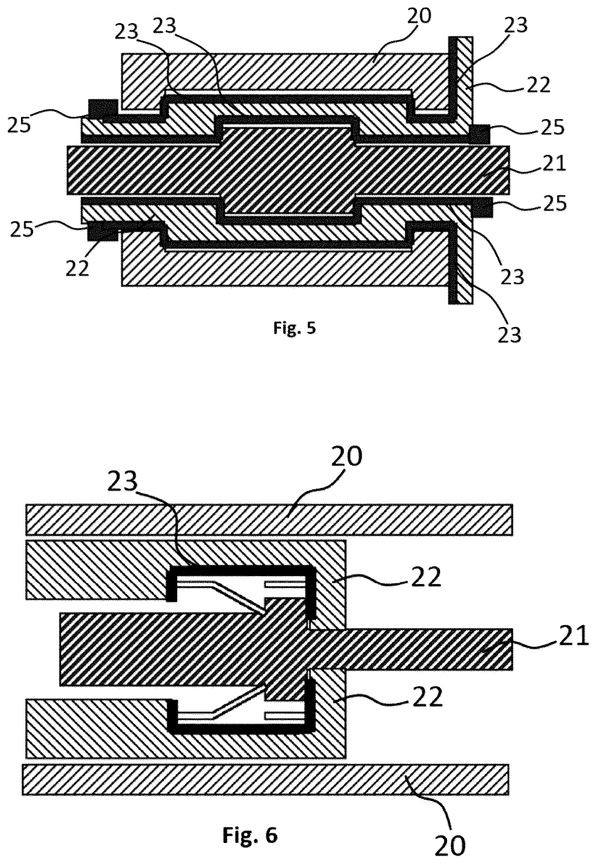

FIG. 6 shows a partial-discharge protection device with a clip and an electrical contact.

This figure has the same characteristics as that of the previous figures.

In an example of a single-channel or multi-channel electrical connector, retention clips are used to ensure holding of the electrical contacts. These clips are made of insulating (plastic) or conductive material. In both cases, these clips have complex geometries with point shapes and have triple points with a local increase in the electric field. These areas are at higher risk of partial discharges.

The solution described above is used to increase the voltage value of appearance of partial discharges, by metallizing the cavity where the clip is located.

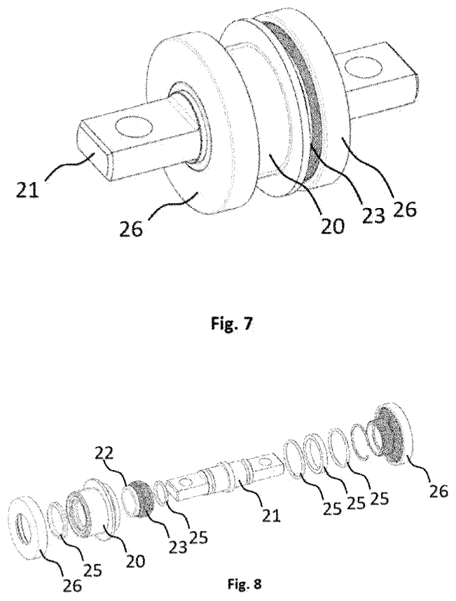

FIG. 7 shows an isometric view of the partial-discharge protection device.

An isometric view generally refers to a three-dimensional graphical representation of an object or a scene in a space using an isometric projection.

The isometric view shows the assembly of the device with the electrical conductor.

FIG. 8 shows an exploded view of the assembly of the protective device with the electrical conductor 21.

The electrical conductor 21 is a connecting bar made of conductive material (e.g. copper or nickel possibly with surface treatment) to which cables (terminals) or busbars can be connected by screwed assembly (bolt) thanks to the two holes.

In another embodiment, cables may be connected to the electrical conductor by crimping.

A metal (or metallized plastic) feedthrough housing 20 allows attachment to a partition and connection to ground.

An insulator 22 and an end insulator 26, metallised on the surface, enable electrical insulation.

An end insulator 26 screwed over the housing 20 increases the path distances between the electrical conductor 21 and the housing 20 and compresses the flexible insulating seal 25.

An insulating flexible seal 25 and an interfacing insulating flexible seal make it possible to avoid the electrical path phenomenon and breakdown between the connector and the housing.

An elastic ring holds the insulator 23 and the end insulator 26.

O-ring seals 25 allow sealing of the feedthrough.

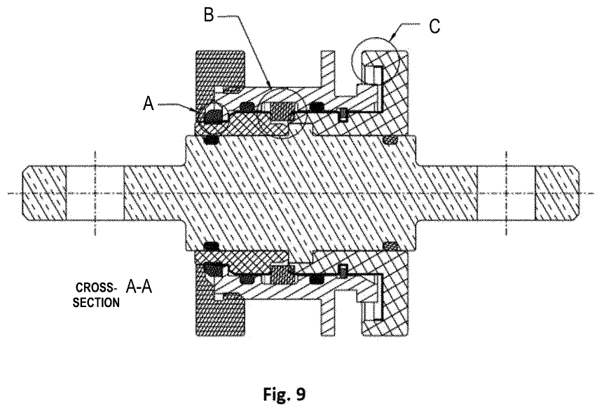

FIG. 9 shows a cross-sectional view of the assembly of the protective device with the electrical conductor 21.

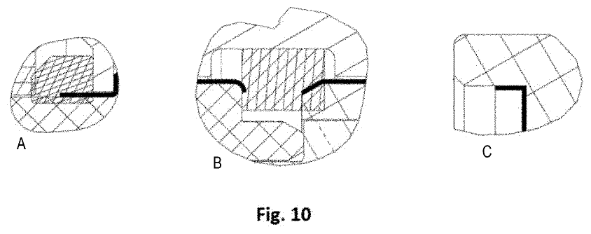

FIG. 10 shows a view of details A, B and C defined in the previous figure and of the ends of the conductive layers 23.

These three details show the stoppages of metallization in the device.

Details A and B show the ends of the conductive layers 23 covered by the seals 25.

Detail C shows a conductive layer end 23 terminating in an area where there is no risk of partial discharges.

It is emphasized that all features, as they arise for a person skilled in the art from the present description, the attached drawings and claims, even if concretely they have only been described in relation to other determined features, both individually and in any combinations, can be combined with other features or groups of features disclosed herein, insofar as this has not been expressly excluded or technical circumstances make such combinations impossible or meaningless.

### LIST OF REFERENCE SIGNS

TABLE 1

| References | Designations |
|---|---|
| 20 | housing |
| 21 | electrical conductor |
| 22 | insulator |
| 23 | conductive layer |
| 25 | seal |
| 26 | End Insulation |

1-5. (canceled)

6. A partial-discharge protection device, the device comprises a connector comprising:
a housing;
an insulator positioned inside the housing and comprising a through-hole;
an electrical conductor positioned inside the through-hole of the insulator;
the insulator comprising a first conductive layer on a part of an outer surface of the insulator, the first conductive layer being positioned between the housing and the insulator; and
the insulator further comprising a second conductive layer on a part of an inner surface of the insulator, an end of the first conductive layer or an end of the second conductive layer extends beyond the housing and on either side of the housing.

7. The device of claim 6, wherein the electrical conductor comprises a surface of contact with the insulator.

8. The device of claim 6, wherein the insulator extends between two ends, each end comprising at least one of an end insulator and an elastomer part.

9. The device of claim 6, wherein the end of the first conductive layer or the end of the second conductive layer is covered by a flexible seal.

10. The device of claim 6, wherein the connector further comprises seals positioned between the insulator and the housing or between the insulator and the electrical conductor, the seals covering the end of the first conductive layer and the end of the second conductive layer.
